(19) United States
(12) Patent Application Publication
(10) Pub. No.: US 2005/0186133 A1
(43) Pub. Date: Aug. 25, 2005

(54) Process for preparing a strontium titanate powder

(76) Inventors: Jianfeng Chen, Beijing (CN); Zhigang Shen, Beijing (CN); Xiaolin Liu, Beijing (CN)

Correspondence Address: HASSE & NESBITT LLC, 7550 CENTRAL PARK BLVD., MASON, OH, 45040, US

(21) Appl. No.: 11/089,381

(22) Filed: Mar. 24, 2005

(30) Foreign Application Priority Data
Sep. 24, 2002 (CN) 02132373.9

(51) Int. Cl. C01G 23/04

(52) U.S. Cl. 423/598

(57) ABSTRACT

This invention provides a process for preparing a strontium titanate powder, which comprises reacting a solution containing Ti⁴⁺ or a solution containing Sr²⁺, or a mixed solution containing Ti⁴⁺ and Sr²⁺ with an alkali solution in a high gravity reactor at a temperature of from about 60° C. to about 100° C. The strontium titanate powder prepared according to the process of the present invention has a small average particle size, narrow size distribution, integrated crystal form, and spheric form. It can be used as a raw material for dielectric, piezoelectric, resistant, sensitive ceramics and other ceramics. Furthermore, the process of the invention for preparing a strontium titanate powder in the high gravity reactor can be used for the continuous preparation of strontium titanate powder.

### FIELD OF THE INVENTION

This invention relates to a process for preparing a strontium titanate powder, particularly to a process for preparing a strontium titanate powder in a high gravity field, and more particularly to a process for preparing a strontium titanate powder continuously by using a high gravity reactor. According to the process, an ultra-fine strontium titanate powder having a particle size within a desired range is obtained in control.

### BACKGROUND OF THE INVENTION

ABO₃ perovskite-type composite oxides, a kind of important inorganic compound, can be used as various multifunctional materials. Among them, strontium titanate (SrTiO₃) ceramic is a novel multifunctional ceramic material for electronic components. As compared with BaTiO₃ material, strontium titanate (SrTiO₃) ceramic has not only better dielectric properties, but also improved semiconductor properties, improved temperature stability and higher resistance. Thus, it can be used to manufacture mid-high voltage ceramic capacitors with high capacity, grain boundary barrier layer capacitors, varistors and multifunction sensors. Therefore, the investigation of strontium titanate, particularly the powder thereof, is a continuously active field. Recently, with the rapid development of technology, requirements for electronic ceramic components with high precision, high reliability, multifunction and micromation became necessary. The key premise to meet the above requirements is to prepare pure, ultra-fine, and uniform powder material. At present, the preparation of strontium titanate is mainly focused on the following aspects: preparation process, structural properties, formation dynamics and mechanisms, the structures and properties of SrTiO₃-based dopants, and the like. Recently, electronic components have become more miniaturized, more multifunctional, have increased performance, and further integrated, to meet the requirements of the above trends.

It is desired to obtain a strontium titanate powder having the following properties: (1) a relatively smaller particle size, generally less than 200 nm in average; (2) narrower particle size distribution; (3) spherical morphology; (4) good crystallinity; and (5) relatively lower sintering temperature. The resulting electronic ceramic materials prepared by such strontium titanate powder as raw material have good sintering character and packed density, good dielectric property and low sintering temperature. Therefore it has the advantages of reducing the need for expensive inside-electrodes, reducing the volume of electronic devices, and the like.

Many studies have shown that the properties of some materials are related to the concentration of the defects thereof, and the preparation process is the key factor which determines the defects of the material and the concentration of the defects. Therefore scientific workers are attempting to seek a process for preparing nano-sized strontium titanate and the dopant thereof. Previously, the processes for preparing strontium titanate mainly included the solid phase processes, gas phase processes and liquid phase processes (wet chemical processes). The solid phase reaction process is presently used widely in industry due to its simple process and low cost. However, the powder prepared by this process has low purity, large particle size and wide particle size distribution, and the compositions of the powder cannot be controlled easily. Therefore, it is difficult to meet the requirements for manufacturing ceramic devices with high performance. The gas phase process has the disadvantages of complex devices and high production cost. Therefore, it is difficult to be used widely in industry. As compared with the solid phase process, the liquid phase method is a more desired process for manufacturing high purity nano-sized powder with regard to operation conditions, raw materials, and production costs. The liquid phase process can be divided into hydrothermal process, sol gel process and chemical precipitation process. For example, Tong Sun et al. (Journal of electron devices, 1996, Vol. 19(4): pp. 230-234) have prepared an ultra-fine SrTiO₃ powder by using a hydrothermal process, and found that a perovskite phase ultra-fine SrTiO₃ powder having high purity can be synthesized at a temperature of 140° C. by using strontium nitrate and tetrabutyl titanate as raw material. Siqiang Hu et al. (Engineering Chemistry & Metallurgy, 1994, Vol. 15(4): pp. 316-321) have prepared an ultra-fine SrTiO₃ crystalline powder by using Sr(OH)₂ and Ti(OH)₂ as the precursors of SrTiO₃ crystalline powder, which is synthesized in a hydrothermal process at a temperature range of 150° C. to 200° C. for 1 h. Gerhard Pfaffet al. (J. Mater. Chem. 1993, Vol. 3(7): pp. 721-724) have prepared SrTiO₃, Sr₂TiO₄, Sr₃Ti₂O₇, and Sr₄Ti₃O₁₀ by dissolving SrO into acetic acid, then mixing the solution with methanol, and reacting the resulting mixture with Ti(OBu)₄ dissolved in isopropanol at different stoichiometry to obtain gels, then drying, and sintering at above 900° C. Kumar et al. (J. Am. Ceram. Soc., 1999, Vol. 82(10): pp. 2580-2584) have prepared a M″TiO₃ powder as follows: M″(OOCCH₃)₂ (M″=Ba, Sr) dissolved in acetic acid is mixed with Ti(OBuⁿ)₄ dissolved in isopropanol to form a stable precursor solution of M″(OOCCH₃)₂—CH₃COOH—(CH₃)₂CH₂OH—Ti(OBuⁿ)₄, then the precipitator such as an alkali NaOH solution is added to the solution, then M″TiO₃ precipitate is produced at the temperature of 85 to 90° C. with atmospheric pressure. After the precipitate is calcined, the M″TiO₃ powder, meeting the required stoichiometry and having less agglomeration, and a particle size of 60 to 100 nm, can be produced.

The above processes which are generally multi-step reactions with complex processes need to be reacted at high temperature and/or high pressure, or to be calcined at high temperature to obtain the strontium titanate powder with integrated crystal form; therefore, the above processes for preparing strontium titanate make the costs of production and equipment relatively higher. Furthermore, after reaction, they need complex post-treatments to obtain a strontium titanate powder meeting the required stoichiometry and having integrated crystal form. Since most of the above processes are discontinuous, the powder qualities of between batches are different.

Thus, the present invention is expected to meet the recent requirements for developing electronic components that are more miniaturized, more multifunctional, have increased performance, and further integrated; and to obtain strontium titanate powder having a small average particle size, narrow particle size distribution, good crystallinity, spheric crystal form, and low sintering temperature, thereby to provide a process, which can be operated simply and carried out at lower temperature and atmospheric pressure compared to the processes in the prior art, and to obtain the strontium titanate powder having desired average particle size in control. The present invention also provides a process according to which strontium titanate can be obtained without being calcined before sintering, and has integrated crystal form meeting the required stoichiometry, and does not need further treatments, where the costs of production and equipment can be reduced and the process can be industrialized.

One aspect of the present invention is a process according to which strontium titanate powder can be prepared at lower temperature and atmospheric pressure.

Another aspect of the present invention is a process according to which strontium titanate powder having desired average particle size, particularly ultra-fine strontium titanate powder, more particularly nano-sized strontium titanate powder, can be obtained in control.

Another aspect of the present invention is a process according to which strontium titanate powder can be prepared continuously.

Still another aspect of the present invention is a process according to which strontium titanate powder having a small average particle size and narrow particle size distribution can be prepared.

### SUMMARY OF THE INVENTION

The present invention provides a process for preparing a strontium titanate powder. The process includes providing an ion solution comprising metal ions selected from Ti⁴⁺, Sr²⁺, and a mixture thereof and providing an alkali solution. The process further involves reacting the ion solution with the alkali solution in a high gravity field, typically in a high gravity reactor, at a temperature of about 60° C. to about 100° C. Preferably, a mixed ion solution containing Ti⁴⁺ and Sr⁺ is reacted with an alkali solution in the high gravity reactor. Optionally, the resulting slurry containing the ultra-fine strontium titanate powder was subjected to the post treatments, such as aging, filtrating, washing, drying, and the like, according to the conventional methods, to obtain the strontium titanate powder having properties as desired.

The process according to the present invention can be used for the continuous preparation of strontium titanate powder.

The strontium titanate powder prepared according to the process of the present invention preferably has a nano-scaled or submicron-scaled primary particle size, and a controllable average particle size and narrow particle size distribution. The slurry containing said strontium titanate powder can also be prepared according to the process of the present invention.

### BRIEF DESCRIPTION OF THE FIGURES

FIG. 1 is an XRD scanning graph of the strontium titanate powder of the present invention.

FIG. 2 is a TEM electron micrograph of the strontium titanate powder of the present invention.

FIG. 3 is a process chart of preparing strontium titanate powder by using two reactants according to the present invention, wherein (a) is not dispersed, and (b) is dispersed by using a dispersant.

FIG. 4 is a process chart of preparing strontium titanate powder by using three reactants according to the present invention.

FIG. 5 is a schematic diagram of the high gravity reactor used in the present invention.

### DETAILED DESCRIPTION OF THE INVENTION

As used herein, “high gravity reactor” (or “high gravity reactor of rotating packed bed”) means a rotating bed reactor, or a rotating packed bed (RPB) reactor, such as a Higee reactor, that generates a high gravity field, typically greater than earth gravity, and within the range of 10-100,000 m/s². Examples of high gravity reactors have been disclosed in the prior art, such as Chinese Patent ZL 95107423.7, Chinese Patent ZL 92100093.6, Chinese Patent ZL 95105343.4, Chinese Patent Application for invention CN00100355.0, and Chinese Patent Application for invention CN00129696.5. Examples of high gravity reactors have been also disclosed in the prior art, such as U.S. application Ser. Nos. 10/436,854 (publication no. U.S. 2003/02/9370A1), 10/707,048, 10/880,724 and 10/945,299, all of which are incorporated herein by reference in their entirety.

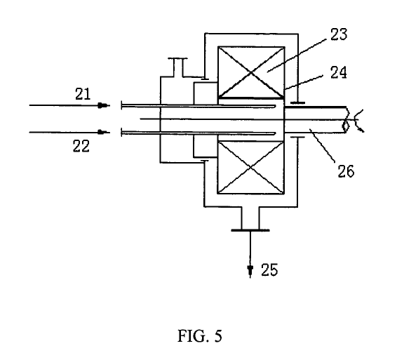

The high gravity reactor of the present invention is used for liquid-liquid reaction, and includes a distributor with at least two inlets. As shown in FIG. 5, it includes the inlets 21 and 22 for introducing different liquid materials, and the reactants are reacted in the rotating packed bed during the reaction. Typically, the liquids move centrifugally outward from the center of the reactor and through the rotating packed beds. The packed bed fillings that can be used in the rotating packed bed of the present invention can include, but are not limited to, metal material and nonmetal material, such as silk screen, porous plate, corrugated plate, foam material, and regular packing.

Referring to FIG. 5, according to one embodiment of the present invention, the present invention provides a process for preparing strontium titanate powder, which involves introducing a mixed solution containing Ti⁴⁺ and Sr⁺ and an alkali solution into the high gravity reactor through the liquid inlets 21 and 22 respectively, then reacting the mixed solution containing Ti⁴⁺ and Sr²⁺ with the alkali solution in the packing material 23 at a temperature of from about 60° C. to about 100° C. during the rotating process of the rotary drum 24 driven by the axis 26, then the reacting mixture (slurry) leaving from the high gravity reactor through the liquid outlet 25. The reaction mixture from the liquid outlet 25 is collected, and then subjected to post treatments including stirring and aging, filtrating and drying, to obtain strontium titanate powder having the average particle size as desired. The process for preparing the strontium titanate powder of the present invention can be used for the continuous preparation of strontium titanate powder.

In the above-mentioned process, the mixed aqueous solution containing Ti⁴⁺ and Sr²⁺ can be obtained by providing an aqueous solution containing Ti⁴⁺, then adding an aqueous solution containing Sr²⁺ into the above-mentioned aqueous solution containing Ti⁴⁺, or by adding the aqueous solution containing Ti⁴⁺ into an aqueous solution containing Sr²⁺.

In one embodiment of the present invention, as referred to FIG. 3, the mixed solution containing Sr²⁺ and Ti⁴⁺ prepared above is placed into the storage tank 6, then pumped by the pump 7 to the rotating packed bed 3 through the liquid inlet 4 of the rotating packed bed after being measured by the flowmeter 5. Meanwhile, the alkali solution from the storage tank 1 is pumped by the pump 10, to the rotating packed bed 3 through the liquid inlet 2 after being measured by flowmeter 9. During the rotating process of the rotating packed bed 3, the mixed solution containing Sr²⁺and Ti⁴⁺ contacts and reacts well with the alkali solution in the porous packing material layer (not shown) of the rotating packed bed 3 at a temperature of from about 60° C. to about 100° C.

In another embodiment of the present invention, as referred to FIG. 4, the solution containing Ti⁴⁺, the solution containing Sr²⁺, and the alkali solution can also be fed into the rotating packed bed 3 through the liquid inlets 2, 4 and 5 respectively, during the rotating process of the rotating packed bed 3. The solution containing Ti⁴⁺, the solution containing Sr²⁺, and the alkali solution contact each other and react well in the porous packing material layer (not shown) of the rotating packed bed 3 at a temperature of from about 60° C. to about 100° C., preferably, at greater than about 70° C., more preferably, at greater than about 80° C.

The reaction mixture containing reaction product is fed into the stirring vessel 8 through the liquid outlet of the reactor after reaction. Preferably, said reactant mixture collected in the stirring vessel 8 is stirred and aged for a period of time, for example, for 3 to 5 minutes, in the stirring vessel. Then the aged slurry is filtrated and washed with water, preferably with deionized water, at a temperature of from about 60° C. to about 100° C., and then dried, to obtain the SrTiO₃ powder.

According to the process of the present invention, after the high gravity reactor is started up, during the reaction, the rotating speed of the rotor of the rotating packed bed is from about 100 rpm to about 10,000 rpm, preferably from about 150 rpm to about 5,000 rpm, more preferably, from about 200 rpm to about 3,000 rpm, and most preferably, from about 500 rpm to about 2,000 rpm. In terms of centripetal acceleration, the reaction proceeds at 10-100,000 m/s², preferably from 22.5-25,000 m/s², more preferably at from 40-9,000 m/s², and most preferably at from: 250-4,000 m/s².

In the process of the present invention, the material that can provide Sr²⁺ is selected from, but not limited to, the group consisting of strontium chloride, strontium nitrate, strontium hydroxide, strontium oxalate, strontium perchlorate, strontium acetate and organic salts of strontium such as alkoxyl compounds of strontium, and mixtures thereof, preferably selected from the group consisting of strontium chloride, strontium nitrate and organic salts of strontium, such as alkoxyl compounds of strontium.

In the process of the present invention, the material that can provide Ti⁴⁺ is selected from, but not limited to, the group consisting of titanium chloride, titanium nitrate, titanium hydroxide, titanium oxychloride and organic salts of titanium, and mixtures thereof.

In the process of the present invention, the alkali used therein is selected from the group consisting of hydroxides of alkali metals or alkaline earth metals, ammonium hydroxide, ammonium tetramethyl hydroxide, and mixtures thereof, preferably selected from the group consisting of sodium hydroxide, potassium hydroxide, and ammonium tetramethyl hydroxide.

According to the process of the present invention, the flow rate of the alkali solution, and the solution containing Ti⁴⁺, the solution containing Sr²⁺, or the mixed solution thereof can be varied in a very wide range, and can be selected based on conditions including diameter of the rotating packed bed, rotary speed, reaction temperature, and concentration of the reactants. Preferably, the ratio of the volume flow rates of the alkali solution and of a solution that is selected from the solution containing Ti⁴⁺, the solution containing Sr²⁺, or the mixed solution thereof, is in a range of from about 0.5 to about 10. The concentration of Ti⁴⁺ in the solution containing Ti⁴⁺ is from about 0.1 to about 5.0 mol/L, preferably, from about 0.3 to about 3.0 mol/L, and more preferably, from about 0.3 to about 1.5 mol/L. The concentration of Sr²⁺ in the solution containing Sr²⁺ is from about 0.1 to about 5.0 mol/L, preferably, from about 0.3 to about 3.0 mol/L, and more preferably, from about 0.3 to about 1.5 mol/L. Solutions having the above-mentioned concentrations can be mixed to obtain the solution containing Ti⁴⁺ and Sr²⁺. According to the process of the present invention, the mole ratio of the Sr/Ti in the solution containing Ti⁴⁺ and Sr²⁺ is from about 0.80 to about 1.20, preferably, from about 0.90 to about 1.10, and more preferably, from about 0.95 to about 1.08.

According to the process of the present invention, the concentration of the alkali solution is from about 0.5 to about 15.0 mol/L, preferably, from about 1.0 to about 10.0 mol/L, and more preferably from about 2.5 to about 7.0 mol/L. According to the process, the pH value of the reaction mixture is maintained at more than about 10 after reaction, and preferably, the pH value is greater than about 12.5.

According to the process of the present invention, the material that can provide Ti⁴⁺ and Sr²⁺ and the alkali solution can be reagents in industrial grade or analytical pure. If the material and alkali solution are reagents in industrial grade, then it is preferred to refine them to remove the impurities thereof.

According to the process of the present invention, during the reaction, additives including a crystal form controlling agent or a dispersant also can be added into the solution containing Ti⁴⁺ and/or Sr²⁺ or the alkali solution, to facilitate the particles further being dispersed, refined, and to narrow the particle size distribution, and to control the form of the strontium titanate particle and improve its properties.

The reacted slurry is discharged through the outlet of the rotating packed bed and collected in the storage tank with stirrer. The slurry in the storage tank with stirrer is stirred and aged, filtrated, washed, and then dried, to obtain the strontium titanate powder.

### Analytical Test and Testing Results

The strontium titanate powder prepared according to the process of the present invention can be analyzed by a transmission electron microscope. In one embodiment of the present invention, 0.05 g of the strontium titanate powder is dispersed in ethanol, and then oscillated in an ultrasonic cleaner. Then the suspension is dropped onto a copper grid used for observing with an electron microscope. The primary particle size and the form of the particle are analyzed by a transmission electron microscope (HITACHI-800 mode, made in Japan).

The results show that the average particle size of the strontium titanate powder prepared according to the process of the present invention is very small, and that the particle size distribution thereof is narrow. The average particle size thereof is less than about 500 nm, preferably, less than about 250 nm, and more preferably, less than about 100 nm. For example, the average size is from about 500 nm to about 5 nm, preferably, from about 250 nm to about 10 nm, and more preferably, from about 100 nm to about 10 nm.

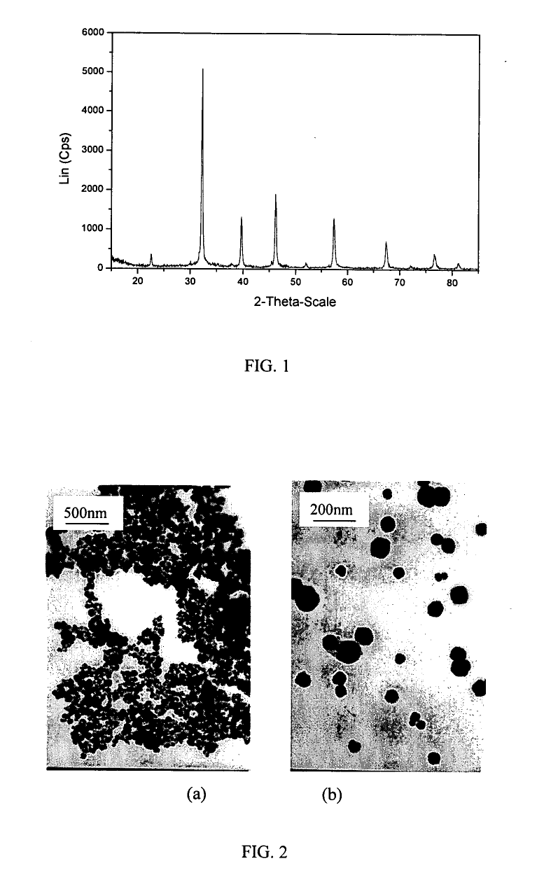

The crystal phases of the strontium titanate powder prepared according to the process of the present invention can be analyzed by an X-ray diffractometer such as a XRD-600 model diffractometer made in Shimadzu, Japan (CuKa, scanning speed 4°/min). FIG. 1 is a XRD scanning graph of the strontium titanate powder of the present invention. The XRD scanning graph of the strontium titanate powder prepared according to the present invention shows that the crystal form of the strontium titanate powder prepared according to the present invention agrees well with the standard XRD spectra JCPDS of strontium titanate powder having cubic phase, and no peak of impurities appears in the spectra.

Therefore, as compared with the processes of the prior art, the process of the present invention can controllably produce a strontium titanate powder which has a predetermined average grain size, uniform particle size distribution and a regular crystal form, and the slurry containing said powder in a short time in a continuous process, due to using the high gravity reactor. The powder does not need to be calcined before ceramics sintering. Therefore, a great deal of energy consumption and the cost of production can be saved.

Moreover, the strontium titanate powder prepared according to the process of the invention has the advantages that the strontium titanate powder has a small average particle size, integrated crystal form, and spherical shape. In addition, the strontium titanate powder as it is or after being doped with other elements or oxides of other elements is very suitable for use as raw material for dielectric, piezoelectric, voltage withstanding, sensitive ceramics and other ceramics.

### EXAMPLES

Hereinafter, the embodiments within the scope of the present invention will be further described and explained in detail by the following non-limiting examples for preparing the strontium titanate powder according to the present invention. The examples are for illustrative purposes and are not intended to limit the scope of the invention. It will be understood by those of ordinary skill in the art that various changes may be made therein without departing from the spirit and scope of the present invention. All concentrations used in the examples are measured by weight, unless mentioned otherwise.

### Example 1

6.0 mol/L of NaOH solution was prepared, wherein the NaOH was a analytical reagent. The NaOH solution was fed into the stainless NaOH storage tank 1. The preparation of a mixed solution containing SrCl₂ and TiCl₄ involved the following steps: preparing a solution in which the concentration of SrCl₂ was 2.0 mol/L and a solution in which the concentration of TiCl₄ was 2.0 mol/L, respectively; preparing the mixed solution in which the total concentration of [SrCl₂]+[TiCl₄] was 1 mol/L, and the [SrCl2]/[TiCl4] ratio was 1.05, by adding deionized water. The mixed solution containing SrCl₂ and TiCl₄ prepared above was fed into the storage tank 6.

After the high gravity reactor was started up, the mixed solution containing SrCl₂ and TiCl₄, in which the total concentration of [SrCl₂]+[TiCl₄] was 1 mol/L, was pumped by the pump 7, to the rotating packed bed 3 through the liquid inlet 4 of the rotating packed bed after being measured by the flowmeter 5, with a flow rate being set at 40 L/hr. And the NaOH solution from the NaOH storage tank 1 was pumped by the pump 10, to the rotating packed bed 3 through the liquid inlet 2 after being measured by flowmeter 9, with a flow rate being set at 35 L/hr. The high-gravity level, g, (here,

$${g}_{r} = {( \frac{2 π N}{60} )}^{2} \cdot \frac{{d}_{in} + {d}_{out}}{2} ,$$

where N is the rotating speed of the rotator rpm, dᵢₙ=50 mm is the inner diameter and dₒᵤₜ=150 mm is the outer diameter), was 1579 m/s². The mixed solution containing SrCl₂ and TiCl₄ contacted and reacted well with the NaOH solution in the porous packing material layer of the rotating packed bed 3 after entering into the high gravity reactor. During the reaction, the temperature of the rotating packed bed was controlled at about 90° C., and the rotating speed was set at 1440 rpm. The reacted slurry was collected in the stirring vessel 8, wherein the mixed solution containing SrCl₂ and TiCl₄ reacted and the NaOH solution was continuously pumped for 10 min.

The reacted slurry was stirred and aged in the stirring vessel for 3 to 20 min. Then the aged slurry was filtrated and washed three times with deionized water at a temperature of about 95° C., and then dried in a drier at about 100° C. to obtain the SrTiO₃ powder.

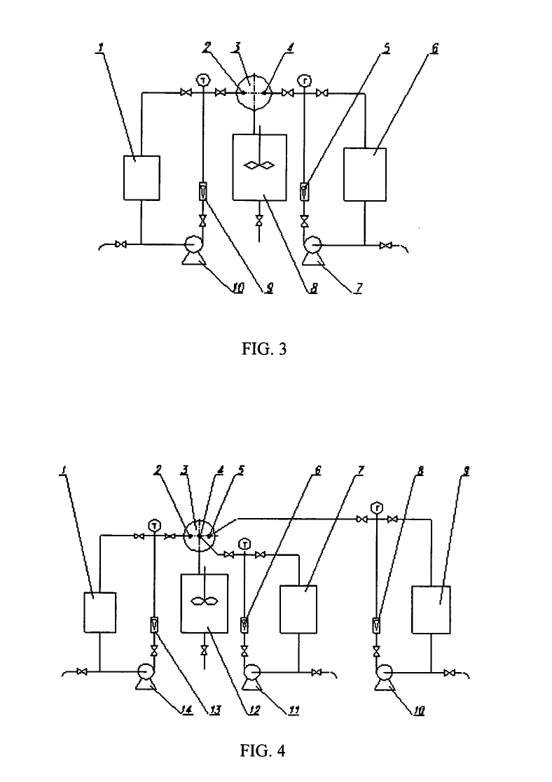

0.1 g of the powder was dispersed in 50 ml of ethanol, and then oscillated in an ultrasonic cleanser for 20 min. Then the suspension was dropped onto a copper grid used for observing with an electron microscope. The primary particle size and the form of the particle were analyzed by a transmission electron microscope (TEM) (HITACHI-800, made in Japan), and the TEM electron micrograph thereof is shown in FIG. 2. As referred to in FIG. 2, the analytical results show that the resulting strontium titanate powder is in spheric form and has an average particle size of about 70 nm.

The crystal phases of the strontium titanate powder were analyzed by an X-ray diffractometer ((CuKa, scanning speed 4°/min) (XRD-600 model, made in Shimadzu, Japan)). The XRD scanning graph thereof is shown in FIG. 1. From FIG. 1, it was found that the powder was a strontium titanate crystal having cubic phases.

### Example 2

6.0 mol/L of NaOH solution, and a mixed solution containing Sr²⁺ and Ti⁴⁺ in which the total concentration of [SrCl₂]+[TiCl₄] was 1.0 mol/L and the [SrCl2]/[TiCl4] ratio was 1.05 were prepared according to the same procedure as described in Example 1.

After the high gravity reactor was started up, the mixed solution containing SrCl₂ and TiCl₄ was pumped from the storage tank 6 by the pump 7, to the rotating packed bed 3 at a flow rate of 80 L/hr through the liquid inlet 4 of the rotating packed bed after being measured by the flowmeter 5, according to the same procedure as described in Example 1. And the flow rate of the NaOH solution was adjusted to a range of 40 L/hr to 90 L/hr. The mixed solution containing SrCl₂ and TiCl₄ contacted and reacted well with the NaOH solution in the porous packing material layer of the rotating packed bed 3 after entering into the high gravity reactor under conditions where the temperature was controlled at about 85° C. During the reaction, the rotating speed was set at 1000 rpm. The reacted slurry was collected in the stirring vessel 8, wherein the mixed solution containing SrCl₂ and TiCl₄ reacted and the NaOH solution was continuously pumped for 20 min.

The reacted slurry was stirred and aged in the stirring vessel for 5 to 20 min. Then the aged slurry was filtrated and washed three times with deionized water whose temperature was about 95° C., and then dried in a drier at about 100° C. to obtain the SrTiO₃ powder.

The analytical results show that the resulting strontium titanate powder was in spherical shape, and had an average particle size of from about 10 nm to 150 nm. The particle size of the particle was changed from 10 nm to 150 nm with the flow rate being reduced. Furthermore, the resulting strontium titanate powder had a uniform particle size and a narrow particle size distribution.

### Example 3

8.0 mol/L of KOH solution, and a mixed solution in which the total concentration of [SrCl₂]+[TiCl₄] was 2 mol/L and the [SrCl₂]/[TiCl₄] ratio was 1.05 were prepared according to the same procedure as described in Example 1.

The reaction was conducted in the high gravity reactor at 70° C. according to the steps as described in Example 1, to obtain the slurry containing strontium titanate powder.

The reacted slurry was stirred and aged in the stirring vessel for 3 to 20 min. Then the aged slurry was filtrated and washed three times with deionized water at a temperature of about 95° C., and then dried in a drier to obtain the SrTiO₃ powder.

The analytical results show that the characteristics of the resulting production were the same as those of the strontium titanate powder prepared according to Example 1.

### Example 4

5 mol/L of NaOH solution, and a mixed solution in which the total concentration of [SrCl₂]+[TiOCl₂] was 3 mol/L and the [SrCl₂]/[TiOCl₂] ratio was 1.0 were prepared according to the same procedure as described in Example 1.

The reaction was conducted in the high gravity reactor at 95° C. according to the steps as described in Example 1, to obtain a slurry containing the strontium titanate powder. 200 ml of 1 mol/L of NaOH solution was added into the stirring vessel used for collecting the reaction mixture in advance.

The reacted slurry was stirred and aged in the stirring vessel for 3 to 5 min. Then the aged slurry was filtrated and washed three times with deionized water at a temperature of about 95° C., and then dried in a drier to obtain the SrTiO₃ powder.

The analytical results showed that the resulting strontium titanate powder had an average particle size of 50 nm and the other characteristics thereof were the same as those in Example 1.

### Example 5

6 mol/L of NaOH solution, and a mixed solution in which the total concentration of [Sr(OH)₂]+[Ti(OH)₄] was 3 mol/L and the [Sr(OH)₂]/[Ti(OH)₄] ratio was 0.95 were prepared according to the same procedure as described in Example 1.

The reaction was conducted in the high gravity reactor at 95° C. according to the steps as described in Example 1, to obtain the slurry containing strontium titanate powder.

The reacted slurry was stirred and aged in the stirring vessel for 20 to 30 min. Then the aged slurry was filtrated and washed three times with deionized water at a temperature of about 95° C., and then dried in a drier to obtain a SrTiO₃ powder.

The analytical results showed that the characteristics of the resulting strontium titanate powder were the same as in Example 1.

### Example 6

7.0 mol/L of (CH₃)₄NOH solution, and the mixed solution in which the total concentration of [SrCl₂]+[TiCl₄] was 1 mol/L and the [SrCl₂]/[TiCl₄] ratio was 1.05 were prepared according to the same procedure as described in Example 1.

The slurry containing the strontium titanate powder was prepared according to the same procedure as described in Example 1.

The reacted slurry was stirred and aged in the stirring vessel for 5 to 10 min. Then the aged slurry was filtrated and washed three times with deionized water at a temperature of about 95° C., then dried in a drier to obtain the SrTiO₃ powder.

The analytical results showed that the characteristics of the resulting strontium titanate powder were the same as in Example 1.

### Example 7

6.0 mol/L of NaOH solution, 0.7 mol/L of SrCl₂ solution and 0.7 mol/L of TiCl₄ solution were prepared according to the same procedure as described in Example 1, and the [SrCl₂/TiCl₄] ratio was 1.10.

In a similar manner as described in Example 1, the SrCl₂ solution from the storage tank 7 was fed into the rotating packed bed 3 through the liquid inlet 4; the TiCl₄ solution from the storage tank 9 was fed into the rotating packed bed 3 through the liquid inlet 5; and the NaOH solution from the storage tank 1 was fed into the rotating packed bed 3 through the liquid inlet 2. The flow rates of the SrCl₂ solution, the TiCl₄ solution and the NaOH solution were 150 ml/min, 150 ml/min, and 270 ml/min, respectively.

After the high gravity reactor was started up, the rotating speed of the high gravity reactor was set at 1800 rpm. Then SrCl₂, TiCl₄ and NaOH in the mixture solution contacted and reacted well in the porous packing material layer of the rotating packed bed 3 at about 95° C.

The slurry leaving from the high gravity reactor was collected, and then stirred and aged in the stirring vessel for 3 to 5 min. Then the aged slurry was filtrated and washed three times with deionized water with a temperature of about 90 to 100° C., and then dried in a drier to obtain the SrTiO₃ powder.

The analytical results showed that the resulting strontium titanate powder had an average particle size of about 50 nm, and the other characteristics thereof were the same as those in Example 1.

1. A process for preparing strontium titanate powder, comprising the steps of: a) providing an ion solution comprising metal ions selected from Ti⁴⁺, Sr²⁺, and a mixture thereof; b) providing an alkali solution; and c) reacting the ion solution with the alkali solution under a high gravity field at a temperature of from about 60° C. to about 100° C.

2. The process according to claim 1 wherein the alkali solution used in the process comprises a solution of an alkali selected from the group consisting of the hydroxides of alkali metals or alkaline earth metals, ammonium hydroxide, or ammonium tetramethyl hydroxide.

3. The process according to claim 1 wherein the alkali solution used in the process comprises a solution of an alkali selected from the group consisting of sodium hydroxide, potassium hydroxide or ammonium tetramethyl hydroxide.

4. The process according to claim 1 wherein the Sr²⁺ ions are provided by a material selected from the group consisting of strontium chloride, strontium nitrate, strontium hydroxide, strontium oxalate, strontium perchlorate, strontium acetate, organic salts of strontium and alkoxyl compounds of strontium, and mixtures thereof.

5. The process according to claim 1 wherein the Sr²⁺ ions are provided by a material selected from the group consisting of strontium chloride, strontium nitrate, strontium hydroxide, strontium oxalate, strontium perchlorate, strontium acetate, organic salts of strontium and alkoxyl compounds of strontium, and mixtures thereof.

6. The process according to claim 3 wherein the Sr²⁺ ions are provided by a material selected from the group consisting of strontium chloride, strontium nitrate, strontium hydroxide, strontium oxalate, strontium perchlorate, strontium acetate, organic salts of strontium and alkoxyl compounds of strontium, or mixtures thereof.

7. The process according to claim 1 wherein the Ti⁴⁺ ions are provided by a material selected from the group consisting of titanium chloride, titanium nitrate, titanium hydroxide, titanium oxychloride and organic salts of titanium including alkoxyl compounds of strontium, or mixtures thereof.

8. The process according to claim 2 wherein the Ti⁴⁺ ions are provided by a material selected from the group consisting of titanium chloride, titanium nitrate, titanium hydroxide, titanium oxychloride and organic salts of titanium including alkoxyl compounds of strontium, or mixtures thereof.

9. The process according to claim 3 wherein the Ti⁴⁺ ions are provided by a material selected from the group consisting of titanium chloride, titanium nitrate, titanium hydroxide, titanium oxychloride and organic salts of titanium including alkoxyl compounds of strontium, or mixtures thereof.

10. The process according to claim 4 wherein the Ti⁴⁺ ions are provided by a material selected from the group consisting of titanium chloride, titanium nitrate, titanium hydroxide, titanium oxychloride and organic salts of titanium including alkoxyl compounds of strontium, or mixtures thereof.

11. The process according to claim 1, wherein the high-gravity field is provided by an ultrahigh gravity reactor having a rotating packed bed with speeds ranging from about 10 m/s² to about 100,000 m/s².

12. The process according to claim 10, wherein the high-gravity field is provided by an ultrahigh gravity reactor having a rotating packed bed with speeds ranging from about 10 m/s² to about 100,000 m/s².

13. The process according to claim 1 wherein the ratio of the volume flow rates of the alkali solution, and the solution containing Ti⁴⁺ or Sr²⁺ ions, or the mixed solution containing Ti⁴⁺ and Sr²⁺ ions, is from about 0.5 to about 10.

14. The process according to claim 12 wherein the ratio of the volume flow rates of the alkali solution, and the ion solution is from about 0.5 to about 10.

15. The process according to claim 1 wherein the ion solution has an Sr/Ti molar ratio of from about 0.70 to about 1.30.

16. The process according to claim 14 wherein the ion solution has an Sr/Ti molar ratio of from about 0.70 to about 1.30.

17. The process according to claim 1 wherein the concentration of the ion solution containing Ti⁴⁺ is from about 0.1 to about 3.0 mol/L.

18. The process according to claim 16 wherein the concentration of the ion solution containing Ti⁴⁺ is from about 0.1 to about 3.0 mol/L.

19. The process according to claim 1 wherein the concentration of the alkali solution is from about 0.5 to about 15.0 mol/L.

20. The process according to claim 18 wherein the concentration of the alkali solution is from about 0.5 to about 15.0 mol/L.
